(19) United States
(12) Patent Application Publication
(10) Pub. No.: US 2019/0383345 A1
(43) Pub. Date: Dec. 19, 2019

(54) DAMPING DEVICE, VEHICLE INCLUDING DAMPING DEVICE, AND METHOD OF ESTIMATING PHASE ERROR OF DAMPING DEVICE

(71) Applicant: SINFONIA TECHNOLOGY CO., LTD., Tokyo (JP)

(72) Inventors: Yuichi Hamaguchi, Tokyo (JP); Hideaki Moriya, Tokyo (JP)

(73) Assignee: SINFONIA TECHNOLOGY CO., LTD., Tokyo (JP)

(21) Appl. No.: 16/431,930

(22) Filed: Jun. 5, 2019

(30) Foreign Application Priority Data
Jun. 13, 2018 (JP) 2018-113086

(51) Int. Cl. F16F 7/10; F16F 15/00; G05B 17/02

(52) U.S. Cl. CPC F16F 7/1005; G05B 17/02; F16F 15/002

(57) ABSTRACT

A damping device includes a forced phase shifter 3a to calculate a force phase shift to be added to the inverse transfer characteristic stored in the adaptive control algorithm; a fluctuation calculator 3b to calculate a fluctuation of the magnitude of a command vector having amplitude information and phase information when the forced phase shift is added; a memory 3c to preliminarily store a variation in the phase error of the vibration transfer characteristic corresponding to the fluctuation of the magnitude of the command vector; and a phase error estimator 3d to estimate the phase error of the vibration transfer characteristic based on the fluctuation of the magnitude of the command vector calculated by the fluctuation calculator 3b and the variation in the phase error of the vibration transfer characteristic corresponding to the fluctuation of the magnitude of the command vector stored in the memory 3c.

### CROSS-REFERENCE TO RELATED APPLICATIONS

This application claims priority of Japanese Patent Applications No. 2018-113086 filed on Jun. 13, 2018. The contents of the applications are incorporated herein by reference in their entirety.

### BACKGROUND OF THE INVENTION

### Field of the Invention

The present invention relates to a damping device that preliminarily establishes an inverse transfer characteristic of a vibration transfer characteristic of a vibration transfer path from a vibration generator to a target position to be damped and damps a target vibration using the preliminarily established inverse transfer characteristic, a vehicle including the damping device, and a method of estimating a phase error with the damping device.

### Description of the Related Art

A damping device has been known that offsets vibration generated at a vibration source, such as an engine of a vehicle, with an offset vibration generated by a vibration generator, at a target damping position at which vibration is to be damped. Japanese Patent No. 5353662 describes such a known damping device that generates offset vibration at a target position by a vibration generator, the offset vibration having a phase opposite to that of the vibration transmitted from the vibration source to the target position. When an offset signal is to be generated, the amplitude and the phase of the vibration generated at the vibration generator vary during the process of being transmitted from the vibration generator to the target position. Thus, in consideration of the variation in the amplitude and the phase, the vibration generator should generate the offset vibration such that the predetermined offset vibration is applied at the target position. Therefore, in Japanese Patent No. 5353662, the inverse transfer characteristic of the vibration transfer characteristic that varies the amplitude and phase of the vibration transmitted from the vibration generator to the target position is preliminarily stored in an adaptive algorithm, and the offset vibration is calculated with reference to the inverse transfer characteristic for vibration corresponding to the inverse waveform of vibration simulating the target vibration at a target position.

However, the vibration transfer characteristic changes with age and the like. In particular, a change in a phase component of the vibration transfer characteristic causes the vibration transfer characteristic of the system to deviate from the inverse transfer characteristic stored in the adaptive algorithm. This reduces the damping effect and leads to a degradation in ride comfort. In addition, when the change in the vibration transfer characteristic exceeds the stability limit of the adaptive control system, the adaptive control fails.

One effective scheme for fixing such a failure is correcting the inverse transfer characteristic preliminarily stored in the adaptive algorithm. However, such a scheme requires the accurate estimation of the phase error of the vibration transfer characteristic of the system.

The inventor of the present invention focused on reconvergence of a vector after the phase of the inverse transfer characteristic stored in the adaptive control algorithm and discovered that the vector converges in different ways depending on the magnitude of the phase error of the vibration transfer characteristic.

An object of the present invention is to provide a damping device that can appropriately estimate a phase error of the vibration transfer characteristic of a system, a vehicle including the damping device, and a method of estimating a phase error with the damping device.

### SUMMARY OF THE INVENTION

The present invention solves the issues described above through the following solution.

That is, a damping device according to the present invention offsets a vibration generated at a vibration source with an offset vibration generated by a vibration generator at a target position at which the vibration is to be offset by calculating a simulated vibration for offsetting the vibration transmitted from the vibration source to the target position using an adaptive control algorithm, generating the offset vibration at the target position by the vibration generator based on the calculated simulated vibration, detecting a residual vibration remaining as an offset error between the generated offset vibration and the vibration transmitted from the vibration source to the target position, using the adaptive control algorithm to reduce the detected residual vibration remaining as the offset error, preliminarily storing in the adaptive control algorithm an inverse transfer characteristic of a vibration transfer characteristic varying the amplitude and the phase of the vibration transmitted from the vibration generator to the target position, and calculating the offset vibration based on the simulated vibration taking into account the inverse transfer characteristic, the damping device including a forced phase shifter structured to calculate a force phase shift to be added to the inverse transfer characteristic stored in the adaptive control algorithm; a fluctuation calculator structured to calculate a fluctuation of the magnitude of a command vector having amplitude information and phase information corresponding to the amplitude and the phase of a drive command signal driving the vibration generator when the forced phase shift is added by the forced phase shifter; and a memory structured to preliminarily store a variation in the phase error of the vibration transfer characteristic corresponding to the fluctuation of the magnitude of the command vector.

In this way, the damping device according to the present invention can appropriately estimate the phase error of the vibration transfer characteristic of the system on the basis of the fluctuation of the magnitude of the command vector corresponding to a drive command signal driving the vibration generator when the inverse transfer characteristic stored in the adaptive control algorithm is destabilized by intentionally applying a forced phase shift.

As above mentioned, according to the present invention, In this way, the phase error of the vibration transfer characteristic can be appropriately estimated on the basis of the fact that the command vector corresponding to the drive command signal driving the vibration generator has different convergence behaviors when the inverse transfer characteristic stored in the adaptive control algorithm is intentionally destabilized by applying a forced phase shift.

### BRIEF DESCRIPTION OF THE DRAWINGS

FIG. 1 is a schematic view of a damping device according to an embodiment of the present invention applied to a vehicle;

FIG. 2 is a schematic view of a vibration generator including a linear actuator that constitutes the damping device of FIG. 1;

FIG. 3 is a block diagram illustrating a configuration associated with damping control of the damping device in FIG. 1;

FIG. 4 illustrates adaptive filter coefficients and a command vector Ve1A represented by the coefficients;

FIG. 5 is an explanatory view regarding a residual vibration remaining as an offset error between a vibration transmitted from a vibration source to a target position to be damped and an offset vibration;

FIG. 6 is a block diagram illustrating a method of calculating a forced phase shift to be added by the damping device in FIG. 1;

FIGS. 7A to 7C illustrates the behavior of a command vector Ve1A in response to the forced phase shift;

FIGS. 8A to 8C illustrates the behavior of a command vector Ve1A in response to the forced phase shift;

FIGS. 9A to 9C illustrates the behavior of a command vector Ve1A in response to the forced phase shift;

FIGS. 10A and 10B illustrates the behavior of a vector Ve1A when the forced phase shift is performed from a stable state within a stable range of the transfer characteristic phase error;

FIG. 11 is a plot of evaluation reference values V1 and V2 within a stable range of the transfer characteristic phase error;

FIG. 12 is a plot of an evaluation value V within a stable range of the transfer characteristic phase error;

FIG. 13 illustrates a method of calculating the evaluation value V;

FIG. 14 illustrates a method of estimating a phase error Δφ of a vibration transfer characteristic; and

FIG. 15 illustrates a specific example of a method of estimating a phase error Δφ.

### DETAILED DESCRIPTION OF THE EMBODIMENTS

A damping device according to an embodiment of the present invention will be described with reference to the accompanying drawings.

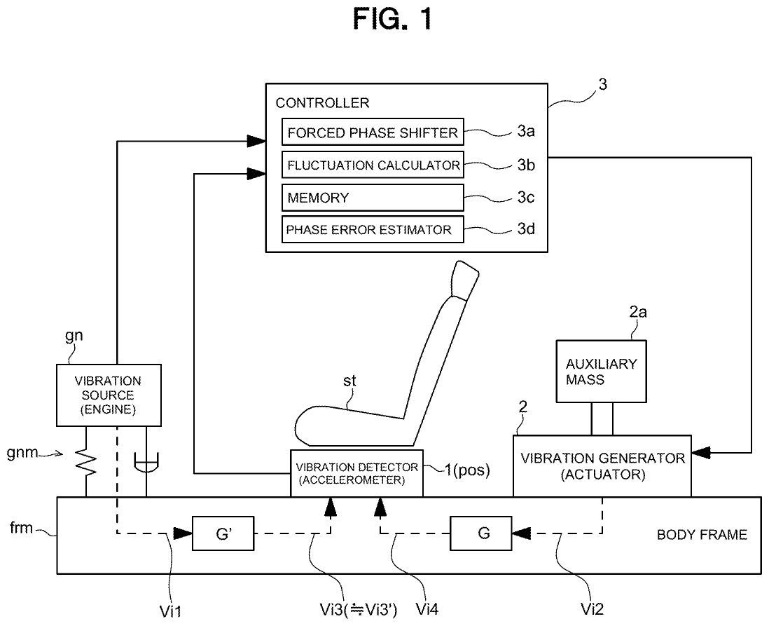

A damping device according to an embodiment, as illustrated in FIG. 1, is mounted on a vehicle, such as an automobile. The damping device includes a vibration detector 1, such as an accelerometer, disposed at a target position pos to be damped, such as a seat st; a vibration generator 2 including a linear actuator 20 generating vibration Vi2 by vibrating a predetermined auxiliary mass 2a; and a controller 3 receiving an ignition pulsed signal of a vibration source gn or engine and a detection signal from the vibration detector 1 and in response transmitting a vibration Vi2 generated at the vibration generator 2, to cause an offset vibration Vi4 to be generated at the target position pos. The damping device causes the vibration Vi3 generated at the vibration source gn, such as an engine mounted on a body frame frm via a mounter gnm, to be offset with the offset vibration Vi4 generated by the vibration generator 2 at the target position pos, subsequently to reduce vibration at the target position pos.

The vibration detector 1 detects a main vibration in the same direction as that of the main vibration of the engine using an accelerometer, and outputs the detected vibration sg {=A1 sin (θ+φ)} where θ=ωt.

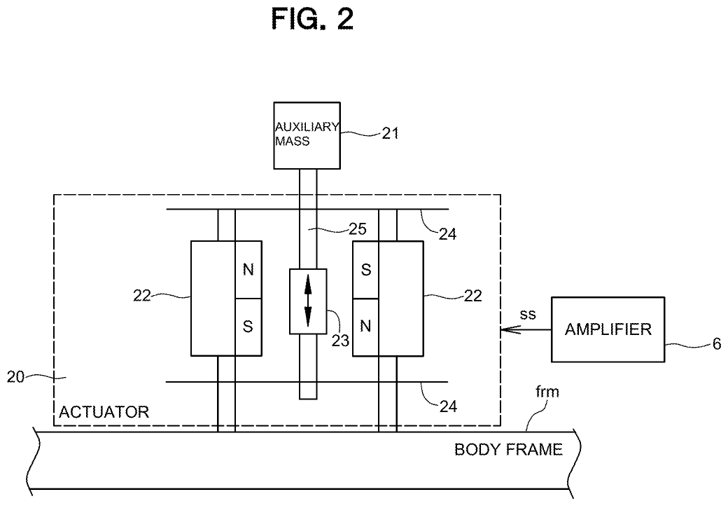

As illustrated in FIG. 2, the linear actuator 20 is of a reciprocal type that includes stators 22 provided with permanent magnets fixed to the body frame frm and causes a mover 23 to reciprocate in the same direction as that of the vibration to be damped (in the up and down direction in FIG. 2). The linear actuator 20 is fixed to the body frame frm such that the direction of the vibration of the body frame frm to be damped and the reciprocation direction (thrust direction) of the mover 23 coincide with each other. The mover 23 is attached to a shaft 25 together with the auxiliary mass 2a. The shaft 25 is supported by the stators 22 via flat springs 24 such that the mover 23 and the auxiliary mass 21 are movable in the thrust direction. The linear actuator 20 and the auxiliary mass 21 constitute a dynamic vibration absorber.

When an alternating current (sine wave current, rectangular wave current) is fed to a coil (not shown) of the linear actuator 20 and the current flows through the coil in a predetermined direction, a magnetic flux flows from the S pole to the N pole of the permanent magnet and forms a flux loop. As a result, the mover 23 shifts in a direction against gravity (upward direction). In contrast, when a current is fed to the coil in a direction opposite to the predetermined direction, the mover 23 shifts in the direction of gravity (downward direction). The mover 23 repeats these movements as the flow direction of the alternating current alternates and thereby reciprocates along the shaft 25 in the axial direction relative to the stator 22. As a result, the auxiliary mass 21 joined to the shaft 25 vibrates in the vertical direction. The movable range of the mover 23 is restricted by a stopper not shown. The dynamic vibration absorber including the linear actuator 20 and the auxiliary mass 21 controls the acceleration of the auxiliary mass 21 in accordance with a current control signal ss output from an amplifier 6 to adjust the damping force, thereby can reduce the vibration by offsetting the vibration of the body frame frm.

The controller 3 generates an offset vibration Vi4 that precisely offsets the vibration Vi3 transmitted from the vibration source gn to the target position pos to be damped, by calculating a simulated vibration Vi3′ simulating the vibration Vi3 transmitted from the vibration source gn to the target position pos with an adaptive algorithm and generating the offset vibration Vi4 at the target position pos by the vibration generator 2 on the basis of the calculated simulated vibration Vi3′. The controller 3 detects a residual vibration (error vibration) (Vi3+Vi4) remaining as an offset error between the offset vibration Vi4 transmitted from the vibration generator 2 to the target position pos and the vibration Vi3 with the vibration detector 1. The controller 3 then performs damping control to reduce the detected residual vibration remaining as the offset error by converging the simulated vibration converges to a true value through the adaptive algorithm.

The control system without consideration of the transfer characteristic will now be described with reference to FIGS. 1 to 3. A damping current command Ia of a vibration offset signal is generated on the basis of adaptive filter coefficients (Re and Im). A current control signal ss based on the damping current command Ia is input to the linear actuator 20 to generate an offset vibration Vi4 at the target position pos through the vibration generator 2, the offset vibration Vi4 having a phase opposite to that of the vibration Vi3 from the vibration source gn. The frequency f of the vibration Vi3 at the target position pos is recognized on the basis of the vibration Vi1 generated at the vibration source gn that is associated with an ignition pulsed signal of the engine. The recognized frequency f is input to a basic-electrical-angle calculator 51 to calculate a basic electrical angle θ. A reference-wave generator 52 generates a sine wave sin θ and a cosine wave cos θ, which are reference waves, on the basis of the calculated basic electrical angle θ.

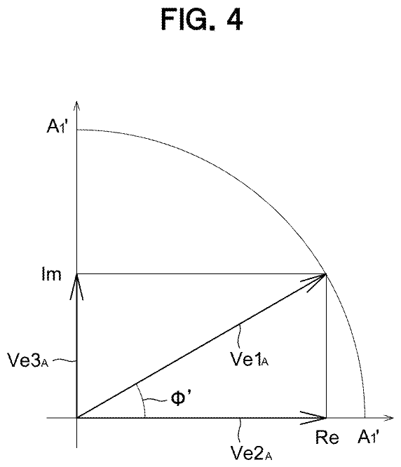

Vibration transmitted to the target position from the vibration generator 2 offsets the source vibration at an offset unit 64 represented by an adder and a residual vibration remains. The residual vibration or vibration sg {=A1 sin(θ+φ)} detected by the vibration detector 1 is multiplied by 2μ (twice the convergence coefficient μ) at a multiplier 53, multiplied by the sine wave sin θ and cosine wave cos θ, which are reference waves, at multipliers 54 and 55, respectively, and integrated by adding the previous value during each operation at integrators 56 and 57. The results are calculated as the adaptive filter coefficients Re and Im for adaptive control and can be expressed as (Re, Im)=(A1′ cos ϕ′, A1′ sin ϕ′). Vectors Ve2A and Ve3A can be defined as illustrated in FIG. 4, where the horizontal axis represents the adaptive filter coefficient Re and the vertical axis represents the adaptive filter coefficient Im. The composite vector of the vectors Ve2A and Ve3A is vector Ve1A. (Hereafter, the composite vector Ve1A is referred to as command vector Ve1A).

Adding the result at the adder 60 generates the damping current command Ia {=−1×A1′ sin(θ+ϕ′)} of the vibration offset signal as inverted phase sine wave signal of the detected vibration sg. While the integration is repeated, A′ and ϕ′ converge to values corresponding to the true values A and φ and the vibration is further offset. Since the basic frequency f and the phase θ are constantly varying, the control is performed by following such constant variation.

As described above, multiplying the adaptive filter coefficients Re and Im by the reference sine wave sin θ and the reference cosine wave cos θ, respectively, and then adding the products yields a simulated vibration A1′ sin(θ+ϕ′). However, in actuality, the transfer characteristic affects the vibration from the vibration generator 2 before the vibration reaches the target position pos. The transfer characteristic varies the amplitude component and the phase component. Thus, in this embodiment, a transfer characteristic compensator 61 generates transfer characteristic compensation signals in which the inverse transfer characteristics (inverse transfer functions) of the amplitude component and the phase component are taken into account in the reference wave. In specific, the amplitude component 1/G of the inverse transfer characteristic specific to the recognized frequency f is retrieved from preliminarily stored amplitude components of the inverse transfer characteristic corresponding to difference frequencies. Similarly, the phase component P of an inverse transfer characteristic specific to the recognized frequency f is retrieved from preliminarily stored phase components of the inverse transfer characteristics corresponding to different frequencies.

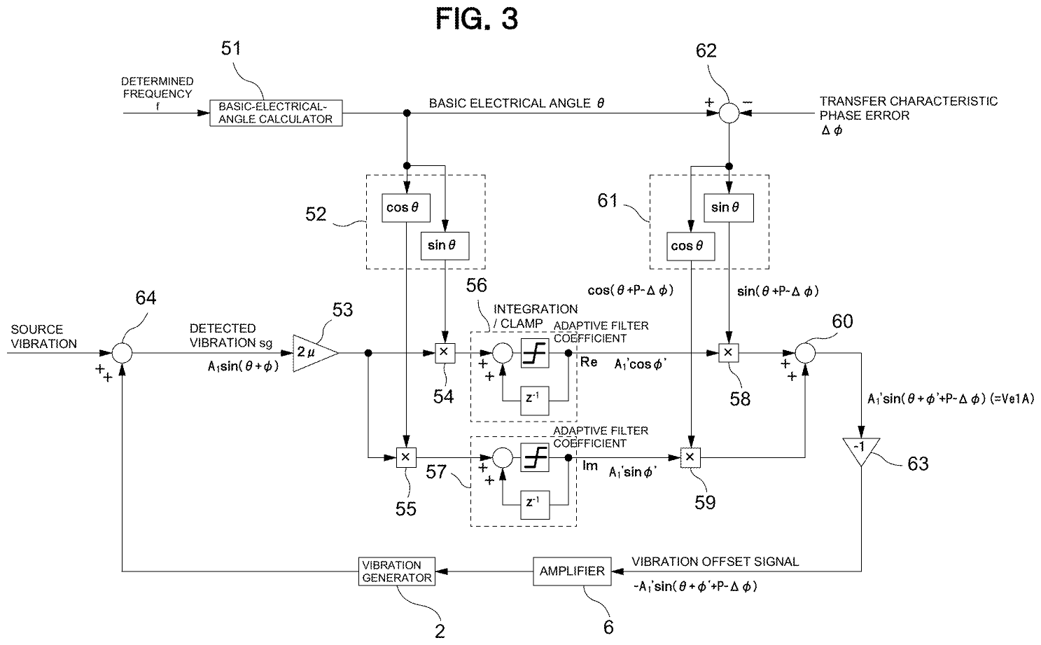

In the following description on the vibration offset signal based on the adaptive filter coefficients Re and Im, the inverse transfer characteristic with the phase component P will be described, but the description on the inverse transfer characteristic with the amplitude component 1/G is omitted. Thus, the transfer characteristic compensator 61 generates a sine wave sin(θ+P) and a cosine wave cos(θ+P) as transfer characteristic compensation signals taking into account in the phase component P of the inverse transfer characteristic when the phase component P of the inverse transfer characteristic is specified based on the recognized frequency f and there is no phase error Δφ, as described below. The amplitude component 1/G is not shown in FIG. 3 because it is not considered here. These transfer characteristic compensation signals are multiplied by vibration offset signals based on the adaptive filter coefficients Re and Im at the multipliers 58 and 59, respectively, added together, and comes to a vibration offset signal A1′ sin(θ+P) to be output finally. If the phase component P specific to the transfer characteristics matches the actual transfer characteristics of the vehicle, and the electrical angle θ+φ of the vibration offset signal matches the actual electrical angle θ+φ of the vibration at the target position pos, the vibration at the target position pos should approach zero.

However, as described above, the vibration transfer characteristic changes with age. Thus, for example, as illustrated in FIG. 3, when a transfer characteristic phase error Δφ is input to a phase variation input unit 62 represented by an adder and thus the phase component of the vibration transfer characteristic is shifted only by the transfer characteristic phase error Δφ, damping control is performed to converge the simulated vibration to a true value through the adaptive algorithm.

This is equivalent to the transfer characteristic compensator 61 generating a sine wave sin(θ+P−Δφ) and a cosine wave cos(θ+P−Δφ) as phase difference compensation signals taking into account the phase component P of the inverse transfer characteristic. The phase component P of the inverse transfer characteristic is offset during transmission of the offset signal. The error −Δφ, which is illustrated at a position before the vibration offset signal is output in the block diagram, is actually an error that occurs during the transmission of the offset signal and is not recognized under the control.

Thus, in a control block in consideration of the phase error Δφ, the multipliers 58 and 59 respectively multiply the applied filter coefficients (Re, Im)=(A1′ cos φ′, A1′ sin φ′) by the phase difference compensation signals sin(θ+P−Δφ) and cos(θ+P−Δφ), respectively, which take into account the phase of the inverse transfer characteristic, and the adder 60 adds the results to generate a simulated vibration Vi3′ {=A1′ sin(θ+φ′+P−Δφ)} of the detected vibration sg. The multiplier 63 multiplying the simulated vibration Vi3′ by −1 to generate an opposite phase sine wave signal of a damping current command Ia {=−A1′ sin(θ+φ′)+P+Δφ} of the offset vibration Vi4.

At first, the control works well because the phase component P of the inverse transfer characteristic is close to zero. That is, as illustrated in FIG. 1, the damping current command Ia of the offset vibration Vi4 is fed to the vibration generator 2 via the amplifier 6, and the offset vibration Vi4 is generated at the target position pos. The adder 64 adds the vibration Vi3 transmitted from the vibration source gn to the target position pos and the offset vibration Vi4 transmitted from the vibration generator 2 to the target position pos. The residual vibration remaining as the offset error between the offset vibration Vi4 and the vibration Vi3 is detected by the vibration detector 1. Subsequently, damping control is performed to converge the simulated vibration to a true value through the adaptive algorithm so as to reduce the detected residual vibration remaining as the offset error with the phase component P of the vibration transfer characteristic shifted only by the transfer characteristic phase error Δφ.

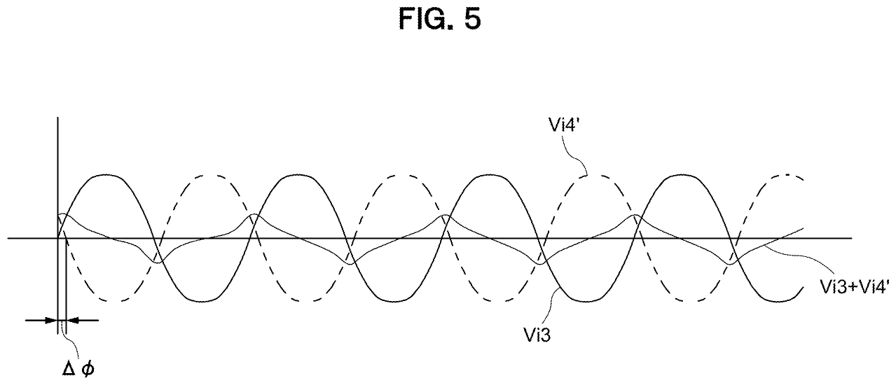

Then, as the phase component P of the vibration transfer characteristics changes with aging of components such as resins and springs of the vehicle, the vibration transfer characteristic of the system deviates from the inverse transfer characteristic of the adaptive algorithm. For example, as illustrated in FIG. 5, when a sinusoidal vibration Vi3 of a source vibration transmitted to a target position pos is to be offset by a sinusoidal offset vibration Vi4 having opposite polarity and the same amplitude, the phase of the offset vibration Vi4 shifts into a vibration Vi4′ while being transmitted to the target position pos. The phase error Δφ between the phases of the two sine waves results in a residual vibration (Vi3+Vi4′). As the phase error Δφ increases, the residual vibration increases. This reduces the damping effect of the command vector Ve1A and thereby degrades the ride comfort. Furthermore, a variation in the characteristic exceeding the stability limit of the adaptive control system can cause failure of the adaptive control. Thus, variation in the vibration transfer characteristic of the system should be understood.

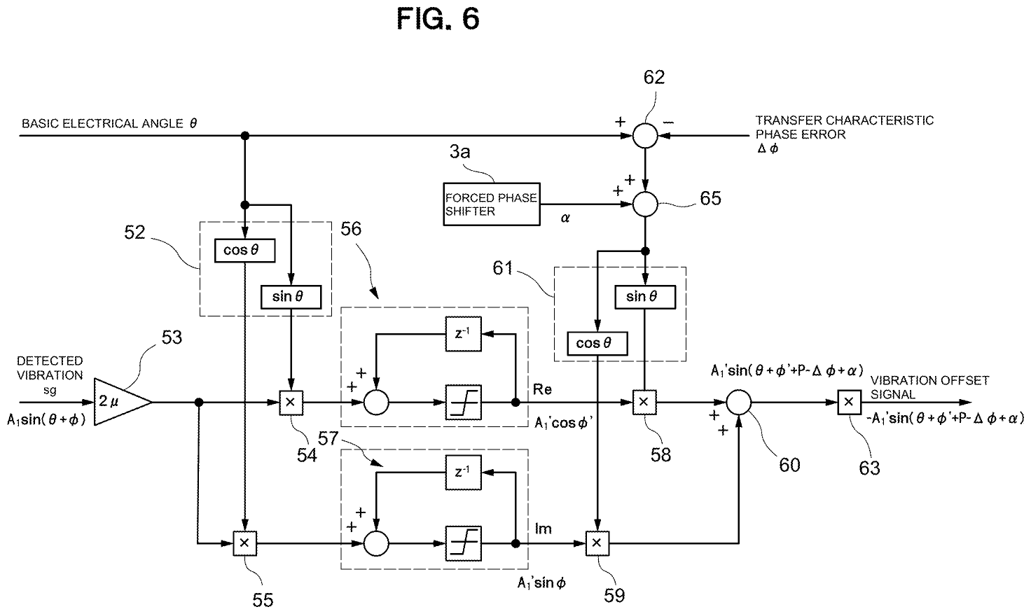

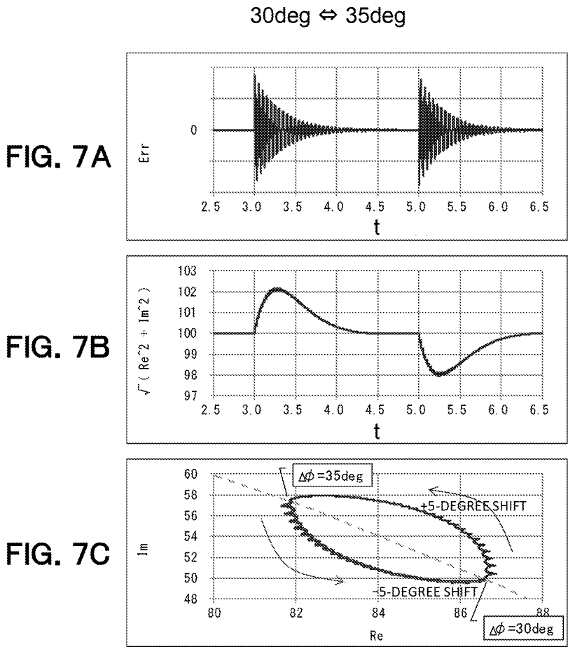

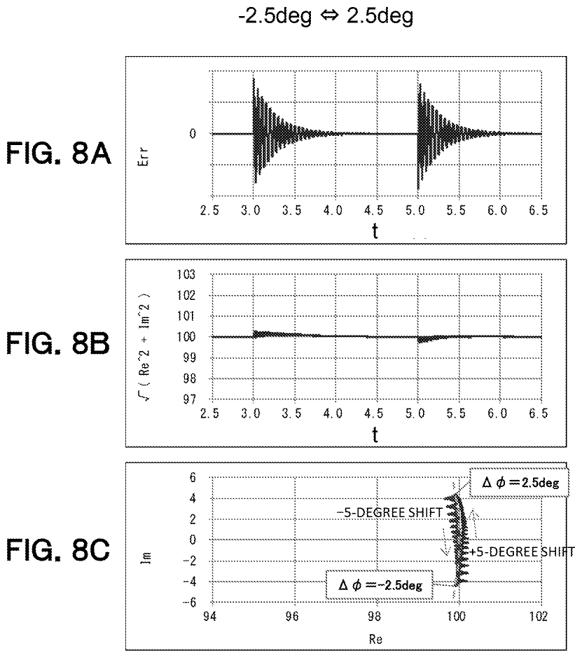

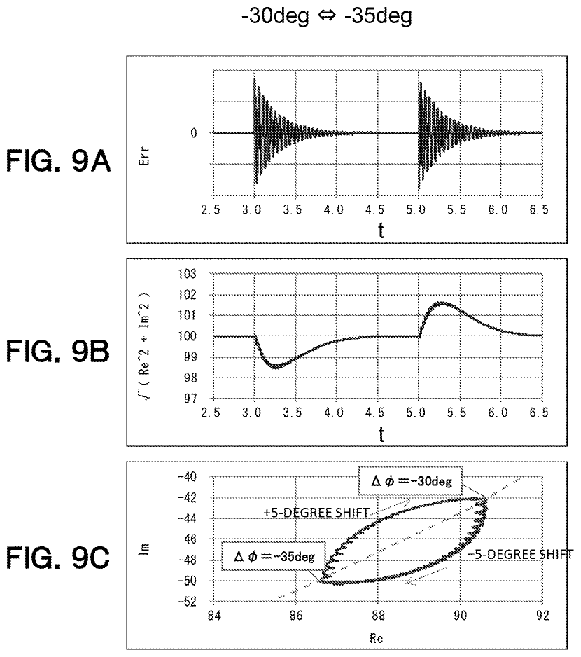

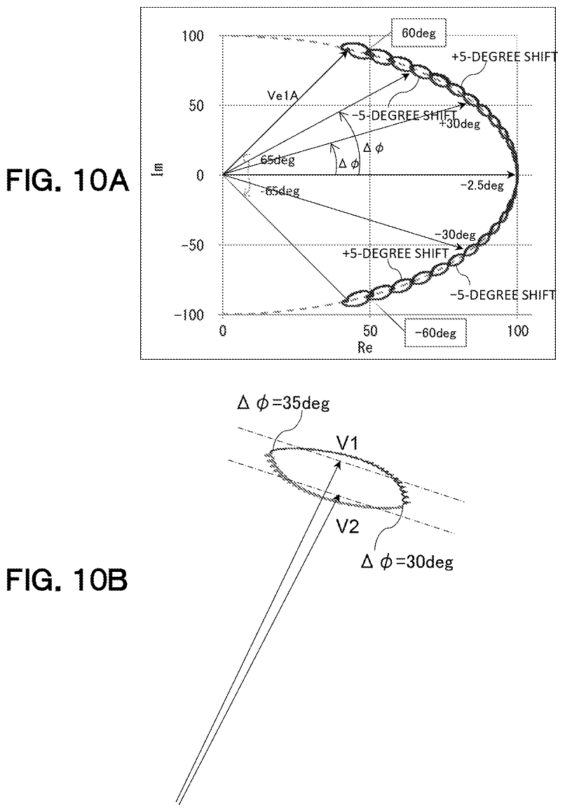

With focus on the behavior of the command vector Ve1A, variation in the vibration transfer characteristic of the system can be understood as variation in the command vector Ve1A. That is, the adaptive filter coefficients indicate the magnitude and direction of the command vector Ve1A. For example, the behavior of the command vector Ve1A during convergence of vibration under a phase error Δφ of 10 degrees differs from that during convergence under a phase error Δφ of 30 degrees. Thus, as illustrated in FIG. 6, a forced phase shifter 3a is provided. The adder 65 adds and subtracts the forced phase shift α to and from the inverse transfer characteristic stored in the adaptive control algorithm, to forcibly shift the phase of the inverse transfer characteristic. FIG. 7A illustrates the time response of a residual vibration Err when a forced phase shift α of 5 degrees is temporarily added and subtracted under a phase error Δφ of 30 degrees; FIG. 7B illustrates the time response of the variation in the command vector Ve1A; and FIG. 7C illustrates the vector locus of the command vector Ve1A. Similarly, FIGS. 8A to 8C illustrates the result obtained when a forced phase shift α of 5 degrees is temporarily added and subtracted under a phase error Δφ of −2.5 degrees. Similarly, FIGS. 9A to 9C illustrates the result obtained when a forced phase shift α of 5 degrees is temporarily added and subtracted under a phase error Δφ of −30 degrees. FIGS. 10A and 10B illustrates the vector locus of the command vector Ve1A for a forced phase shift under phase errors Δφ between −60 to 60 degrees. In addition, in FIGS. 10A and 10B, the looped portions in the vector locus (hereinafter referred to as “loops”) correspond to the loci when a forced phase shift α of 5 degrees is added and subtracted under each phase error Δφ, as illustrated in FIGS. 7C, 8C, and 9C.

In FIG. 10A, a command vector Ve1A from the origin to a point on a loop corresponding to a phase error Δφ has a different length and direction for each phase error Δφ. This indicates the magnitude of a command vector Ve1A correlates with phase error Δφ. In specific, the shape of the loop expands as the phase error Δφ increases. Thus, the expansion of loop can be treated as the fluctuation of the command vector Ve1A relative to the phase error Δφ. In this embodiment, as illustrated in FIG. 10B, the expansion of a loop or the fluctuation of the command vector Ve1A is calculated from the difference V1−V2, where V1 is the mean value of the magnitude of the command vector Ve1A when the phase of the inverse transfer characteristic is forcibly shifted by 5 degree and the vector locus reconverges (when the vector follows half the loop) and V2 is the mean value of the magnitude of the command vector Ve1A when the phase of the inverse transfer characteristic is forcibly shifted by −5 degree and the vector locus reconverges (when the vector follows the other half of the loop). The difference V1−V2 can be defined as an evaluation value V (as described below). In this way, the phase error Δφ can be estimated from the evaluation value V even when the phase error Δϕ is unknown. The fluctuation of the command vector Ve1A is defined by the mean value of the magnitude of the command vector Ve1A when the phase of the inverse transfer characteristic is forcibly shifted by ±5 degrees (when the vector follows the complete loop). Alternatively, the fluctuation of the command vector Ve1A may be defined by the mean value of the magnitude of the command vector Ve1A when the phase of the inverse transfer characteristic is forcibly shifted by +5 or −5 degrees (when the vector follows half the loop).

Thus, the controller 3 according to this embodiment includes a fluctuation calculator 3b, a memory 3c, and a phase error estimator 3d, in addition to the forced phase shifter 3a, as illustrated in FIG. 1. The forced phase shifter 3a actively shifts the phase of the inverse transfer characteristic stored in the adaptive control algorithm to an unstable direction. The controller 3 calculates the fluctuation of the command vector Ve1A corresponding to a drive command signal for driving the vibration generator 2 as an evaluation value V, and estimates the phase error Δφ of the vibration transfer characteristic on the basis of the variation in the phase error Δφ of the vibration transfer characteristic corresponding to the evaluation value V or the fluctuation of the magnitude of the command vector Ve1A stored in the memory 3c.

The forced phase shifter 3a adds the forced phase shift α to an inverse transfer characteristic stored in the adaptive control algorithm. As illustrated in FIG. 6, in this embodiment, a forced phase shift α is temporarily added to the system via the adder 65 under a phase error Δφ in the transmission path. In the control block as described above, presumed various phase variations are input to the phase variation input unit 62 for obtaining evaluation data and subsequently, the phase is shifted by the forced phase shifter 3a to observe and search how the command vector Ve1A can vary.

The forced phase shifter 3a can add a positive forced phase shift α (for example, α=+5 degrees) and a negative forced phase shift α (for example, α=−5 degrees) to the inverse transfer characteristics stored in the adaptive control algorithm. Furthermore, the signal for adding a forced phase shift α may be, for example, a stepped signal that suddenly shifts the phase or a ramped signal that gradually shifts the phase.

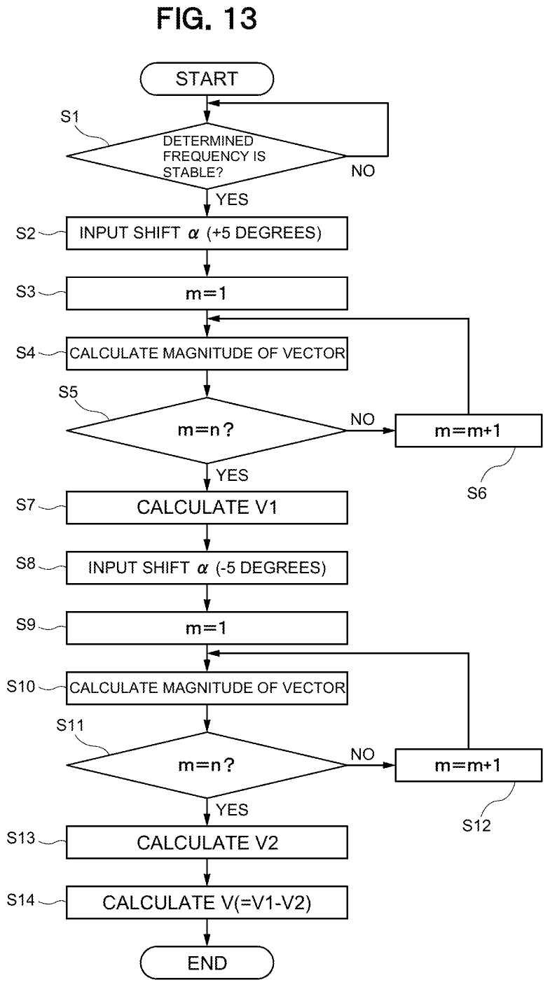

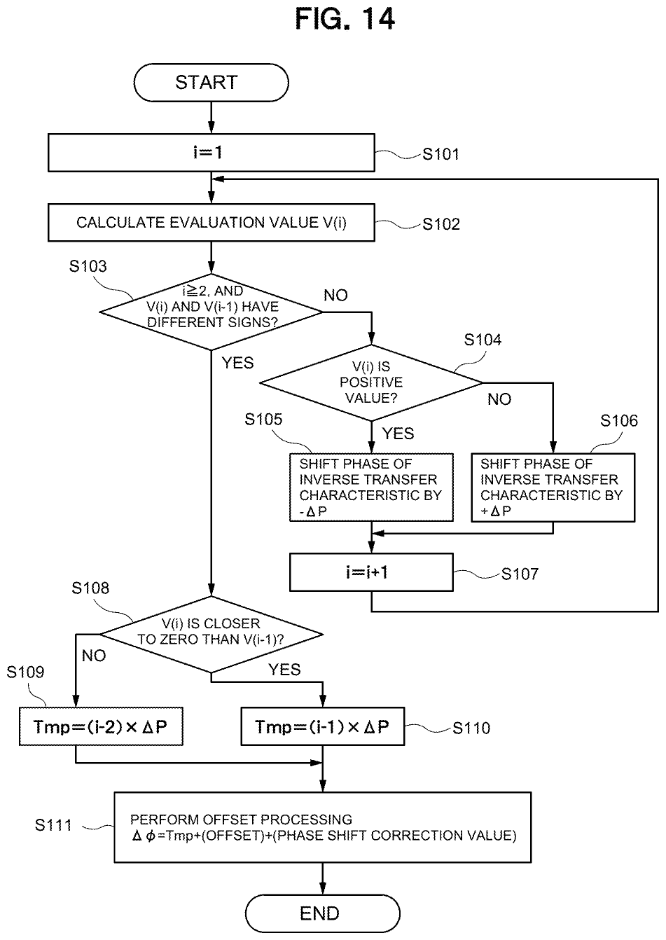

For example, FIG. 7A illustrates the time response of a residual vibration Err when a forced phase shift α of 5 degrees is input at t=3.0 and a forced phase shift α of −5 degrees is input at t=5.0 under a phase error Δφ of 30 degrees; FIG. 7B illustrates the time response of the variation in the command vector Ve1A; and FIG. 7C illustrates the vector locus of the command vector Ve1A. The forced phase shifter 3a varies the magnitude of the command vector Ve1A corresponding to the drive command signal for driving the vibration generator 2 through such forced phase shift, calculates the corresponding fluctuation of the magnitude \sqrt{ }(Re²+Im²) of the command vector Ve1A in FIG. 7B as an evaluation value V, and derives the variation in the phase error Δϕ of the vibration transfer characteristic corresponding to the evaluation value V. FIGS. 13 and 14 illustrate sequences to estimate the phase error Δφ of the vibration transfer characteristic through such forced phase shift during actual driving of the vehicle. These sequences will be described below.

Desirably, the forced phase shifter 3a adds a forced phase shift α to the inverse transfer characteristic while the vehicle on which the damping device is mounted is in a stable damping state, for example, during idling, constant speed running, constant slow acceleration, or constant slow deceleration. A forced phase shift α is added to the inverse transfer characteristic in a stable damping state for evaluation according to this embodiment, as described below.

While the forced phase shift α is added to the inverse transfer characteristic stored in the adaptive control algorithm, the fluctuation calculator 3b illustrated in FIG. 1 calculates the fluctuation of the magnitude of the command vector Ve1A having amplitude information and phase information corresponding the amplitude and phase, respectively, of the damping current command Ia for driving the vibration generator 2. In this embodiment, the fluctuation calculator 3b calculates the evaluation value V representing the fluctuation of the magnitude of the command vector Ve1A using the mean value \sqrt{ }(Re²+Im²) of the command vector Ve1A indicating the expansion of the loop corresponding to the vector behavior while the vibration converges when the forced phase shift α is added as described above. The command vector Ve1A corresponding to the damping current command Ia can be picked up, for example, in the adding process of the adder 60.

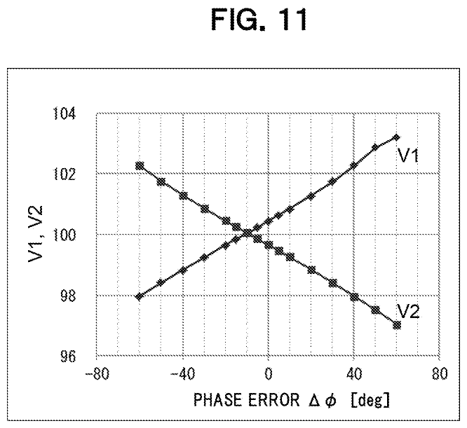

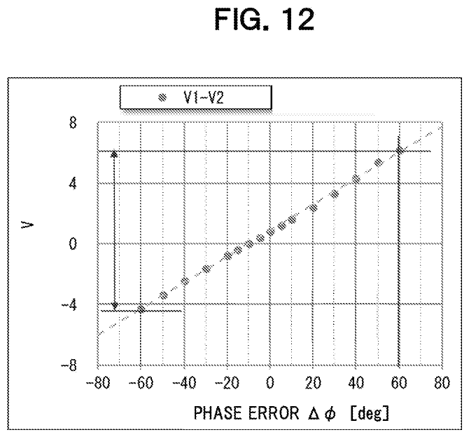

The memory 3c illustrated in FIG. 1 stores the variation in the phase error Δφ in the vibration transfer characteristic corresponding to the evaluation value V representing the fluctuation of the magnitude of the command vector Ve1A when forced phase shift α is added, i.e., the relation between the fluctuation of the magnitude of the command vector Ve1A and the variation in the phase error Δφ. In this embodiment, the memory 3c stores the variation in the phase error Δφ of the vibration transfer characteristic corresponding to an evaluation value V representing the fluctuation of the magnitude of the command vector Ve1A when the forced phase shift α is added (the difference between an evaluation reference value V1 of a forced phase shift of +5 degrees and an evaluation reference value V2 of a forced phase shift of −5 degrees). The evaluation value V is calculated from FIGS. 11 and 12 and Equations 1 and 2.

In this embodiment, the mean value of the magnitude \sqrt{ }(Re²+Im²) of the command vector Ve1A indicating the expansion of the loop corresponding to the vector behavior during convergence of the vibration is defined as an evaluation value V, where V1 is the evaluation reference value of a forced phase shift of +5 degrees, and V2 is the evaluation reference value of a forced phase shift of −5 degrees. Both evaluation reference values can be represented by the following arithmetic expression:

$$V = {\sum }_{m = 1}^{n} ( {Re ( m )}^{2} + {Im ( m )}^{2} ) / n \qquad [ Equation 1 ]$$

In this embodiment, the square-root of sum of squares is applied so that the evaluation reference value is readily comprehensible against a reference value amplitude 100. Thus, the arithmetic expression in this case is as follows:

$$V = {\sum }_{m = 1}^{n} ( \sqrt{{Re ( m )}^{2} + {Im ( m )}^{2}} ) / n \qquad [ Equation 2 ]$$

Here, n in Equations 1 and 2 is the count number for each control sampling immediately after the phase shift.

In short, FIG. 12 illustrates a graph that plots the difference V1−V2 between the mean value V1 of the magnitude of the vector when the tip of the command vector Ve1A follows half the loop and the mean value V2 of the magnitude of the vector when the tip of the command vector follows the other half of the loop against the various phase error Δφ at corresponding times.

The phase error estimator 3d estimates the phase error Δφ of the vibration transfer characteristic on the basis of the evaluation value V representing the fluctuation of the magnitude of the command vector Ve1A when a forced phase shift α is added to the inverse transfer characteristic stored in the adaptive control algorithm and the variation in the phase error Δφ of the vibration transfer characteristic corresponding to the evaluation value V representing the fluctuation of the magnitude of the command vector Ve1A stored in the memory 3c.

As below, a method of estimating the phase error Δφ in the damping device according to this embodiment will be described with reference to FIGS. 7 to 15. The behavior of the command vector Ve1A when the phase of the inverse transfer characteristic stored in the adaptive control algorithm is intentionally shifted and destabilized will now be described. In this embodiment, when the adaptive control is turned on, the adaptive filter coefficients Re and Im function to eliminate the above-mentioned residual vibration Err to zero. The vector behavior corresponds to the behavior of the vector in an Re-Im space defined by a real axis Re and an imaginary axis Im regarding these Re and Im.

The behavior of a command vector Ve1A in response to a forced phase shift is evaluated. In specific, a forced phase shift of +5 or −5 degrees is performed on a vibration transfer characteristic having various phase errors Δφ at t=3.0 when the damping state is stabilized by adaptive control and a forced phase shift of +5 or −5 degrees is performed at t=5.0.

### (Evaluation Conditions)

Source vibration frequency; 20 Hz
Transfer characteristic phase error Δφ; 0, ±30 degrees
Forced phase shift α; ±5 degrees

In this evaluation, the forced phase shift is fixed at 5 degrees at which the residual vibration Err is 10% or less. In this evaluation, the forced phase shift is fixed at 5 degrees. Alternatively, the forced phase shift may be fixed at any other value.

FIGS. 7 to 9 illustrate the evaluated results of the behavior of the command vector Ve1A in response to the forced phase shift, as described above. FIGS. 7 to 9 illustrate the test results for when the phase errors Δφ of the vibration transfer characteristic are +30, −2.5, and −30 degrees, respectively. FIGS. 7A, 8A, and 9A illustrate the time response associated with the residual vibration Err; FIGS. 7B, 8B, and 9B illustrates the time response waveform of the command vector Ve1A; and FIGS. 7C, 8C, and 9C illustrate the behavior of the command vector Ve1A in the Re-Im plane.

As illustrated in FIGS. 7A, 8A, and 9A, when a forced phase shift of +5 degrees is performed at t=3.0 and when a forced phase shift of −5 degrees is performed at t=3.0 under phase errors Δφ of the vibration transfer characteristics of +30, −2.5, and −30 degrees, the residual vibration Err increases and then converges to zero. Thus, FIGS. 7A, 8A, and 9A indicate that the reduction in the damping effect is comparable under the phase errors Δφ of the vibration transfer characteristics of +30, −2.5, and −30 degrees, when the forced phase shift α is constant.

With reference to the behavior of the command vector Ve1A illustrated in FIG. 7C, when a forced phase shift of +5 degrees is performed at t=3.0, the adaptive filter presumes an input of a disturbance equivalent to 5 degrees and converges the phase error Δφ from the coordinates of 30 degrees to the coordinates of 35 degrees. At this time, the locus of the command vector Ve1A passes the outside the arc of radius 100 (dashed line). In contrast, when a forced phase shift of −5 degrees is performed at t=5.0, the locus passes the inside of the arc (dashed line) from the coordinates of 35 degrees to the coordinates of 30 degrees of the phase error Δφ. Since such a locus of the command vector Ve1A is obtained, the time response of the command vector Ve1A for a forced phase shift of +5 degrees is an upward convex change, and the time response of the command vector Ve1A for a forced phase shift of −5 degrees is a downward convex change, as illustrated in FIG. 7B.

The characteristics of the case in which the phase error Δφ of the transfer characteristics is −30 degrees, i.e., the sign of the phase error Δφ of the transfer characteristics is inverted, as illustrated in FIG. 9C, are verified to be inverted in comparison to those of the case in which the phase error Δφ of the transfer characteristic is +30 degree, as illustrated in FIG. 7C. That is, when a forced phase shift of −5 degrees is performed at t=3.0, the adaptive filter presumes an input of a disturbance equivalent to 5 degrees and converges the phase error Δφ from the coordinates of −30 degrees to the coordinates of −35 degrees. At this time, the locus of the command vector Ve1A passes the outside the arc of radius 100 (dashed line). In contrast, when a forced phase shift of +5 degrees is performed at t=5.0, the locus passes the inside of the arc (dashed line) from the coordinates of −35 degrees to the coordinates of −30 degrees. Since such locus of the command vector Ve1A is obtained, the time response of the command vector Ve1A for a forced phase shift of −5 degrees is a downward convex change, and the time response of the command vector Ve1A for a forced phase shift of +5 degrees is an upward convex change, as illustrated in FIG. 9B.

With reference to FIG. 8C, the variation in the command vector 1A is verified to be small under a phase error Δφ of the transfer characteristics of zero or near zero.

FIGS. 10A and 10B illustrates the behavior of the command vector Ve1A when the phase of the inverse transfer characteristic is forcibly shifted in 5-degree increments from a stable state within a range of ±60 degrees, to confirm the tendency of the behavior of the command vector Ve1A in FIGS. 7 to 9 In this embodiment, a forced phase shift (+5 degrees) of the phase of the inverse transfer characteristic is performed to increase the angle of the phase in 5-degree increments from a stable state, and a forced phase shift (−5 degrees) of the phase of the inverse transfer characteristic is performed to decrease the angle of the phase in 5-degree increments from a stable state.

FIGS. 10A and 10B indicates that the turning direction of the locus is found to be inverted relative to the arc (dashed line) of radius 100 at zero or near zero degrees of the phase error. That is, the locus of the command vector Ve1A for a forced phase shift of +5 degrees under a phase error Δφ within the range of 0 to 60 degrees passes the outside of the arc of radius 100 while the locus of the command vector Ve1A of a forced phase shift of −5 degrees under a phase error Δφ passes the inside of the arc. The locus of the command vector Ve1A for a forced phase shift of +5 degrees under a phase error Δφ within the range of −60 to 0 degrees passes the outside of the arc of radius 100 while the locus of the command vector Ve1A of a forced phase shift of +5 degrees under a phase error Δφ passes the inside of the arc.

In addition, as the phase error Δφ increases, the shift of the locus relative to the arc of radius 100 is found to increase. A large shift of the locus indicates a large fluctuation of the magnitude of the command vector Ve1A.

Thus, the phase error Δφ of the vibration transfer characteristic can be estimated on the basis of the vector behavior (the magnitude of the shift of the locus, the fluctuation of the magnitude of the command vector Ve1A) under the control of a +5-degree forced phase shift and a −5-degree forced phase shift.

In this embodiment, when the phase error Δφ of the vibration transfer characteristics is estimated, the difference (V1−V2) between the evaluation reference value V1 for the forced phase shift of +5 degrees and the evaluation reference value V2 for the forced phase shift of −5 degree is defined as the evaluation value V.

FIG. 11 is a graph plotting the evaluation reference values V1 and V2 within the stable range ±60 degrees of the transfer characteristic phase error Δφ. FIG. 12 is a graph plotting the evaluation value V within the stable range ±60 degrees of the transfer characteristic phase error Δφ. In this embodiment, FIG. 12 illustrates a variation in the phase error Δφ of the vibration transfer characteristic corresponding to the evaluation value V representing the fluctuation of the magnitude of the command vector.

As illustrated in FIG. 11, the evaluation reference value V1 when a forced phase shift of +5 degrees is performed and the evaluation reference value V2 when a forced phase shift of −5 degree is performed linearly increase or decrease in proportion as the phase error Δφ of the vibration transfer characteristic.

As illustrated in FIG. 12, the evaluation value V, which is the difference V1-V2 between the evaluation reference values V1 and V2, also linearly increases or decreases in proportion as the phase error Δφ of the vibration transfer characteristic.

As illustrated in FIG. 11 and FIG. 12, the point at which the evaluation reference values V1 and V2 are the same (where the evaluation reference values V1 and V2 balance at V1−V2=0) has a phase error of approximately 10 degrees, not 0 degrees. The offset angle is an error due to discretization arithmetic by adaptive control and is determined by the control calculation cycle and the vibration frequency.

Thus, since the evaluation value V representing the fluctuation of the magnitude of the command vector Ve1A or the difference V1−V2 linearly increases or decreases in proportion as the phase error Δφ of the vibration transfer characteristic, as illustrated in FIG. 12, the phase error Δφ can be directly calculated on the basis of the function of the evaluation value V.

In addition, with reference to FIG. 12, if the fluctuation of the evaluation value V is −4% to +6% (preferably −4% to +4%) in the state immediately before the forced phase shift control (the magnitude of the command vector Ve1A is 100), the phase error Δφ of the vibration transfer characteristic can be determined to be ±60 degrees or less in a stable range. For example, in FIG. 12, when the fluctuation of the evaluation value V is −4% to +4%, the phase error Δφ of the vibration transfer characteristic is −60 to +40 degrees.

In this embodiment, even when the vibration transfer characteristic of the system changes with age and the like and the phase component of the vibration transfer characteristic varies, the phase component P of the inverse transfer characteristic in the adaptive algorithm can be corrected by estimating the phase error Δφ of the vibration transfer characteristic on the basis of the evaluation value V or the difference V1−V2 between the evaluation reference values V1 and V2. Thus, updating the inverse transfer characteristic of the system can prevent the damping effect from reducing with age and keep the damping effect of the adaptive control in a constantly high state.

A method of calculating the evaluation value V according to this embodiment will be described with reference to FIG. 13.

Step S1 determines whether the recognized frequency is stable (whether the damping state is stable). If the recognized frequency is stable, the forced phase shifter 3a adds a forced phase shift α of 5 degrees to the phase of the inverse transfer characteristic stored in the adaptive control algorithm and performs a forced phase shift of +5 degrees in step S2. In step S3, the count number for each control sampling immediately after the phase shift is set to m=1, and in step S4, the magnitude \sqrt{ }(Re²+Im²) of the command vector Ve1A is calculated.

Subsequently, step S5 determines whether the count number m for each control sampling immediately after the phase shift equals n (m=n). If the count number m does not equal n, m is increased by one (m=m+1) in step S6, and the process proceeds to step S4. If m equals n (m=n) in step S5, the fluctuation calculator 3b calculates the evaluation value V1 representing the fluctuation of the magnitude of the command vector Ve1A for the control phase shift in step S7.

Similarly, the forced phase shifter 3a adds a forced phase shift α of −5 degrees to the phase of the inverse transfer characteristic stored in the adaptive control algorithm and performs a forced phase shift of −5 degrees in step S8. In step S9, the count number for each control sampling immediately after the phase shift is set to m=1, and in step S10, the magnitude \sqrt{ }(Re²+Im²) of the command vector Ve1A is calculated.

Subsequently, step S11 determines whether the count number m for each control sampling immediately after the phase shift equals n (m=n). If the count number m does not equal to n, m is increased by one (m=m+1) in step S12, and the process proceeds to step S10. If m equals n (m=n) in step S11, the fluctuation calculator 3b calculates the evaluation value V2 representing the fluctuation of the magnitude of the command vector Ve1A for the control phase shift in step S13.

Subsequently, in step S14, the controller 3 calculates an evaluation value V, which is the difference V1−V2 between the evaluation reference value V1 calculated in step S7 and the evaluation reference value V2 calculated in step S13, and stores the evaluation value V in the memory 3c.

The process then ends.

A method of estimating the phase error Δφ of the vibration damping characteristic on the basis of the evaluation value V according to this embodiment will be described with reference to FIG. 14.

This embodiment describes a method of estimating the phase error Δφ through control of forced phase shift repeated until the sign of the evaluation value V changes (until the relation of the magnitudes of the evaluation reference values V1 and V2 is inversed while comparing the magnitudes of the evaluation reference values V1 and V2).

In step S101, the number of times i is set to one. In step S102, the evaluation value V when the force phase shift amount α (for example, α=5 degrees) is added to and subtracted from the phase of inverse transfer characteristic stored in the adaptive control algorithm. The method of calculating the evaluation value V employs the method described above with reference to FIG. 13. Subsequently, step S103 determines whether the number of times i≥2 and whether the sign of the evaluation value V(i) differ from that of the evaluation value V(i−1). In steps S102 to S107, the phase component P of the inverse transfer characteristic is shifted in increments of ΔP so as to offset the phase error Δφ corresponding to the evaluation value V calculated in step S102, and the number of times i is increased by one until the sign of the evaluation value V changes from positive to negative or vice versa.

In specific, when the evaluation value V calculated in step S102 is a positive value, the phase component P of the inverse transfer characteristic is shifted by −ΔP, the number of times i is increased by one, and then the process proceeds to step S102 to calculate the evaluation value V. In contrast to this, when the evaluation value V calculated in step S102 is a negative value, the phase component P of the inverse transfer characteristic is shifted by +ΔP, the number of times i is increased by one, and then the process proceeds to step S102 to calculate the evaluation value V.

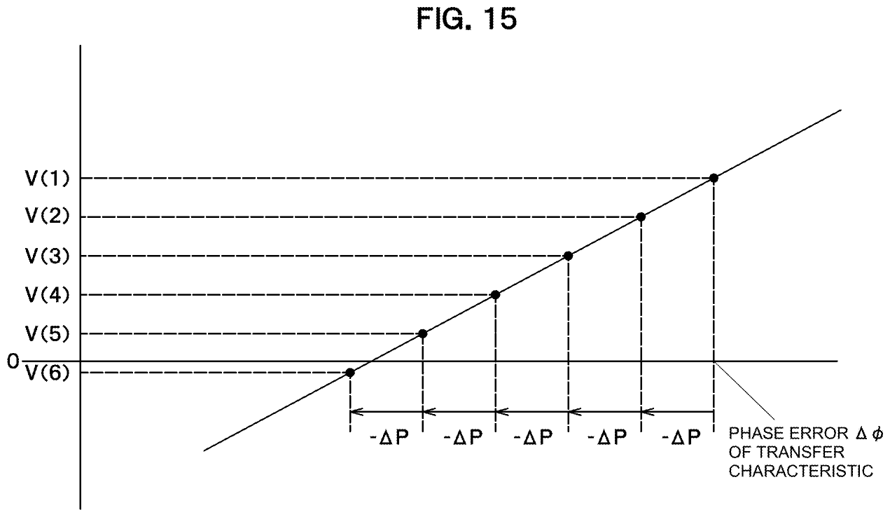

The method of estimating the phase error Δφ will be described with reference to FIG. 15 through specific examples in which the phase error Δφ of the vibration transfer characteristic is a positive value. In FIG. 15, since the evaluation value V(1) calculated at the number of times i=1 is a positive value, the phase component P of the inverse transfer characteristic is shifted by −ΔP and the number of times i is increased by one, to calculate an evaluation value V(2) at the number of times i=2. Since the evaluation value V(2) is a positive value, the phase component P of the inverse transfer characteristic is shifted by −ΔP and the number of times i is increased by one, to calculate an evaluation value V(3) at the number of times i=3. Similarly, since all of the evaluation values V(3), V(4), and V(5) calculated at the number of times i=3, 4, and 5, respectively, are positive values, the shift of the phase component of the inverse transfer characteristic by −ΔP and the calculation of evaluation value Vs are repeated. The evaluation value V(6) calculated at the number of times i=6 is a negative value, and the sign of the evaluation value V changes from positive to negative. Thus, the process proceeds to step S208 because the sign of the evaluation value V(5) at the number of times i=5 differs from that of the evaluation value V(6) at the number of times i=6.

Step S108 determines whether the evaluation value V(i) is closer to zero than the evaluation value V(i−1). In steps S109 and S110 a phase error Tmp is calculated on the basis of the one of the evaluation value V(i) and V(i−1) closer to zero. Subsequently, step 111 performs offset processing on the phase error Tmp calculated, and then the estimation of the phase error Δφ of the vibration transfer characteristic ends.

In the specific example in FIG. 15, the phase error Tmp is calculated from Tmp=(6−1)×ΔP on the basis of the evaluation values V(5) and V(6) having different signs and the evaluation value V(6) being closer to zero than the evaluation value V(5). Thus, the offset value and the phase shift correction value are added to the phase error Tmp to estimate the phase error Δφ of the vibration transfer characteristic. In this embodiment, the offset value is −10 degrees, as illustrated in FIG. 12, and the phase shift correction value is 2.5 degrees, which is the median of 5 degrees to be added or to subtracted because the evaluation value V is calculated by adding and subtracting 5 degrees to and from the phase shift correction value.

As described above, a damping device according to the above-described embodiment offsets a vibration generated at a vibration source gn with an offset vibration Vi4 generated by a vibration generator 2 at a target position pos at which the vibration is to be offset by calculating a simulated vibration Vi3′ for offsetting the vibration Vi3 transmitted from the vibration source gn to the target position pos using an adaptive control algorithm, generating the offset vibration Vi4 at the target position pos by the vibration generator 2 based on the calculated simulated vibration Vi3′, detecting a residual vibration remaining as an offset error between the generated offset vibration Vi4 and the vibration Vi3 transmitted from the vibration source gn to the target position pos, using the adaptive control algorithm to reduce the detected residual vibration remaining as the offset error, preliminarily storing in the adaptive control algorithm an inverse transfer characteristic of a vibration transfer characteristic varying the amplitude and the phase of the vibration transmitted from the vibration generator 2 to the target position pos, and calculating the offset vibration Vi4 based on the simulated vibration Vi3′ taking into account the inverse transfer characteristic, the damping device including a forced phase shifter 3a structured to calculate a force phase shift to be added to the inverse transfer characteristic stored in the adaptive control algorithm; a fluctuation calculator 3b structured to calculate a fluctuation of the magnitude of a command vector Ve1A having amplitude information and phase information corresponding to the amplitude and the phase of a drive command signal driving the vibration generator 2 when the forced phase shift α is added by the forced phase shifter 3a; a memory 3c structured to preliminarily store a variation in the phase error Δφ of the vibration transfer characteristic corresponding to the fluctuation of the magnitude of the command vector Ve1A; and a phase error estimator 3d structured to estimate the phase error Δφ of the vibration transfer characteristic based on the fluctuation of the magnitude of the command vector calculated by the fluctuation calculator and the variation in the phase error Δφ of the vibration transfer 3b characteristic corresponding to the fluctuation of the magnitude of the command vector Ve1A stored in the memory 3c.

In this way, the damping device according to this embodiment can appropriately estimate the phase error Δφ of the vibration transfer characteristic of the system on the basis of the fluctuation of the magnitude of the command vector Ve1A corresponding to a drive command signal driving the vibration generator 2 when the inverse transfer characteristic stored in the adaptive control algorithm is destabilized by intentionally applying a forced phase shift.

In the damping device of this embodiment, the memory 3c stores the variation in the phase error Δφ of the vibration transfer characteristic corresponding to the difference between the fluctuation of the magnitude of the command vector Ve1A calculated by the fluctuation calculator 3b when the forced phase shifter 3a adds a positive forced phase shift α and the fluctuation of the magnitude of the command vector Ve1A calculated by the fluctuation calculator 3b when the forced phase shifter 3a adds a negative force phase shift α having the same magnitude as the positive forced phase shift α.

In this way, the damping device according to this embodiment performs a forced phase shift on the inverse transfer characteristic stored in the adaptive control algorithm to shift the phase of the inverse transfer characteristic, and can return the phase of the inverse transfer characteristic to the state before the forced phase shift by adding a positive forced phase shift α and a negative forced phase shift α having the same magnitude.

A vehicle including the damping device according to this embodiment can provide a comfortable ride to a passenger of the vehicle.

A method of estimating a phase error with a damping device, according to this embodiment, that offsets a vibration generated at a vibration source gn with an offset vibration Vi4 generated by a vibration generator 2 at a target position pos at which the vibration is to be offset by calculating a simulated vibration Vi3′ for offsetting the vibration Vi3 transmitted from the vibration source gn to the target position pos using an adaptive control algorithm, generating the offset vibration Vi4 at the target position pos by the vibration generator 2 based on the calculated simulated vibration Vi3′, detecting a residual vibration remaining as an offset error between the generated offset vibration Vi4 and the vibration Vi3 transmitted from the vibration source gn to the target position pos, using the adaptive control algorithm to reduce the detected residual vibration remaining as the offset error, preliminarily storing in the adaptive control algorithm an inverse transfer characteristic of a vibration transfer characteristic varying the amplitude and the phase of the vibration Vi3 transmitted from the vibration generator gn to the target position pos, and calculating the offset vibration Vi4 based on the simulated vibration Vi3′ taking into account the inverse transfer characteristic, the method including calculating a force phase shift α to be added to the inverse transfer characteristic stored in the adaptive control algorithm; calculating a fluctuation of the magnitude of a command vector Ve1A having amplitude information and phase information corresponding to the amplitude and the phase of a drive command signal driving the vibration generator 2 when the forced phase shift α is added in the calculating the force phase shift α; and estimating a phase error Δφ of the vibration transfer characteristic based on the fluctuation of the magnitude of the command vector Ve1A calculated in the calculating the fluctuation and the variation in the phase error Δφ of the vibration transfer characteristic corresponding to the fluctuation of the magnitude of the command vector Ve1A.

The method of estimating a phase error with a damping device according to this embodiment can appropriately estimate the phase error Δφ of the vibration transfer characteristic of the system on the basis of the fluctuation of the magnitude of the command vector Ve1A corresponding to a drive command signal driving the vibration generator 2 when the inverse transfer characteristic stored in the adaptive control algorithm is destabilized by intentionally applying a forced phase shift α.

The method of estimating the phase error of a damping device according to this embodiment is carried out when the vehicle is in an idling state or a running state at a constant velocity, a constant slow acceleration, or a constant slow deceleration.

In this way, the method of estimating a phase error with a damping device according to this embodiment performs a forced phase shift on the inverse transfer characteristic stored in the adaptive control algorithm in a stable damping state and thus can appropriately estimate the phase error Δφ of the vibration transfer characteristic of the system.

The embodiments of the present invention described above are not limited to the specific configuration of each component described above and may include various modifications without departing from the scope of the present invention.

In the above-describe embodiments, the positive and negative forced phase shifts a are added to the inverse transfer characteristic stored in the adaptive control algorithm. Alternatively, merely a positive or negative phase shift α may be added to the inverse transfer characteristic. In the above-described embodiments, the phase error Δφ of the vibration transfer characteristic is estimated on the basis of the variation in the phase error Δφ of the vibration transfer characteristic in accordance with the evaluation value V, which is the difference between the evaluation reference value V1 when a positive forced phase shift α is added and the evaluation reference value V2 when a negative forced phase shift α is added. Alternatively, the phase error Δφ of the vibration transfer characteristic may be estimated on the basis of the variation in the phase error Δφ of the vibration transfer characteristic in accordance with the evaluation reference value V1 when a positive forced phase shift α is added or the evaluation reference value V2 when a negative forced phase shift α is added.

In the above-described embodiments, the evaluation value V representing the fluctuation of the magnitude of the command vector Ve1A is defined as the mean value \sqrt{ }(Re²+Im²) of the command vector Ve1A indicating the expansion of the loop corresponding to the vector behavior while the vibration converges. Alternatively, any other evaluation value may represent the fluctuation of the magnitude of the command vector Ve1A.

In the above-described embodiments, the damping device includes the phase error estimator 3d. Alternatively, the damping device may include a forced phase shifter 3a, a fluctuation calculator 3b, and a memory 3c, and not a phase error estimator 3d. In such a case, the damping device does not estimate the phase error Δφ but uses the variation in the phase error Δφ of the vibration transfer characteristic in accordance with the fluctuation of the magnitude of the command vector Ve1A stored in the memory 3c to estimate the phase error Δφ of the vibration transfer characteristic. Thus, the advantageous effects of the embodiments of the present invention can be achieved.

What is claimed is:

1. A damping device offsets a vibration generated at a vibration source with an offset vibration generated by a vibration generator at a target position at which the vibration is to be offset by calculating a simulated vibration for offsetting the vibration transmitted from the vibration source to the target position using an adaptive control algorithm, generating the offset vibration at the target position by the vibration generator based on the calculated simulated vibration, detecting a residual vibration remaining as an offset error between the generated offset vibration and the vibration transmitted from the vibration source to the target position, using the adaptive control algorithm to reduce the detected residual vibration remaining as the offset error, preliminarily storing in the adaptive control algorithm an inverse transfer characteristic of a vibration transfer characteristic varying the amplitude and the phase of the vibration transmitted from the vibration generator to the target position, and calculating the offset vibration based on the simulated vibration taking into account the inverse transfer characteristic, the damping device comprising:
a forced phase shifter structured to calculate a force phase shift to be added to the inverse transfer characteristic stored in the adaptive control algorithm;
a fluctuation calculator structured to calculate a fluctuation of the magnitude of a command vector having amplitude information and phase information corresponding to the amplitude and the phase of a drive command signal driving the vibration generator when the forced phase shift is added by the forced phase shifter; and
a memory structured to preliminarily store a variation in the phase error of the vibration transfer characteristic corresponding to the fluctuation of the magnitude of the command vector.

2. The damping device according to claim 1, further comprising: a phase error estimator structured to estimate the phase error of the vibration transfer characteristic based on the fluctuation of the magnitude of the command vector calculated by the fluctuation calculator and the variation in the phase error of the vibration transfer characteristic corresponding to the fluctuation of the magnitude of the command vector stored in the memory.

3. The damping device according to claim 1, wherein the memory stores the variation in the phase error of the vibration transfer characteristic corresponding to a difference between the fluctuation of the magnitude of the command vector calculated by the fluctuation calculator when the forced phase shifter adds a positive forced phase shift and the fluctuation of the magnitude of the command vector calculated by the fluctuation calculator when the forced phase shifter adds a negative forced phase shift, the negative forced phase shift being a forced phase shift the same as the positive forced phase shift but having an opposite sign.

4. The damping device according to claim 2, wherein the memory stores the variation in the phase error of the vibration transfer characteristic corresponding to a difference between the fluctuation of the magnitude of the command vector calculated by the fluctuation calculator when the forced phase shifter adds a positive forced phase shift and the fluctuation of the magnitude of the command vector calculated by the fluctuation calculator when the forced phase shifter adds a negative forced phase shift, the negative forced phase shift being a forced phase shift the same as the positive forced phase shift but having an opposite sign.

5. A vehicle comprising: the damping device according to claim 1.

6. A vehicle comprising: the damping device according to claim 2.

7. A vehicle comprising: the damping device according to claim 3.

8. A vehicle comprising: the damping device according to claim 4.

9. A method of estimating a phase error with a damping device that offsets a vibration generated at a vibration source with an offset vibration generated by a vibration generator at a target position at which the vibration is to be offset by calculating a simulated vibration for offsetting the vibration transmitted from the vibration source to the target position using an adaptive control algorithm, generating the offset vibration at the target position by the vibration generator based on the calculated simulated vibration, detecting a residual vibration remaining as an offset error between the generated offset vibration and the vibration transmitted from the vibration source to the target position, using the adaptive control algorithm to reduce the detected residual vibration remaining as the offset error, preliminarily storing in the adaptive control algorithm an inverse transfer characteristic of a vibration transfer characteristic varying the amplitude and the phase of the vibration transmitted from the vibration generator to the target position, and calculating the offset vibration based on the simulated vibration taking into account the inverse transfer characteristic, the method comprising:
calculating a force phase shift to be added to the inverse transfer characteristic stored in the adaptive control algorithm;
calculating a fluctuation of the magnitude of a command vector having amplitude information and phase information corresponding to the amplitude and the phase of a drive command signal driving the vibration generator when the forced phase shift is added in the calculating the forced phase shift; and
estimating a phase error of the vibration transfer characteristic based on the fluctuation of the magnitude of the command vector calculated in the calculating the fluctuation and the variation in the phase error of the vibration transfer characteristic corresponding to the fluctuation of the magnitude of the command vector stored in the memory.

10. The method of estimating a phase error with a damping device according to claim 9, wherein,
the damping device is mounted on a vehicle, and
the calculating a force phase shift is performed when the vehicle is in an idling state or a running state at a constant velocity, a constant slow acceleration, or a slow deceleration state.
